(19) United States
(12) Patent Application Publication
(10) Pub. No.: US 2006/0232879 A1
(43) Pub. Date: Oct. 19, 2006

(54) Rack mountable data recording assembly

(75) Inventors: Mark D. Strobel, Orono, MN (US); Darren W. Haas, Minnetonka, MN (US)

Correspondence Address: WESTMAN CHAMPLIN & KELLY, P.A., SUITE 1400, 900 SECOND AVENUE SOUTH, MINNEAPOLIS, MN, 55402-3319, US

(73) Assignee: Primera Technology, Inc., Plymouth, MN (US)

(21) Appl. No.: 11/406,043

(22) Filed: Apr. 18, 2006

Related U.S. Application Data
(60) Provisional application No. 60/672,303, filed on Apr. 18, 2005.

(51) Int. Cl. G11B 17/02

(52) U.S. Cl. 360/98.01

(57) ABSTRACT

A recording assembly having a rack mountable housing is disclosed. The rack mountable housing disclosed has a width dimension sized to fit within a standard opening or spacing between rails of the rack. The recording assembly is mounted to rails on the rack via mounting flanges. The mounting flanges include slots which align with openings on the rails to connect the flanges to the rack. In illustrated embodiments, the mounting flanges are formed integral with the housing or on a separate bracket or shelf unit which is secured to the rack to support or mount the data recording assembly.

### CROSS-REFERENCE TO RELATED APPLICATION

The present application is based on and claims the benefit of U.S. provisional patent application Ser. No. 60/672,303, filed Apr. 18, 2005, the content of which is hereby incorporated by reference in its entirety.

### BACKGROUND OF THE INVENTION

Data from hard drives, compact discs “CD”, digital video discs “DVD” and other sources is recorded or copied to discs by data recording devices. These devices for example, can be used to copy data for “back-up” or archival purposes. Typically such devices record data from CDs, DVDs or other data storage devices to blank discs. The process of recording or copying multiple CDs or a large volume of data can require more than one disc. Known data recording devices are designed to automatically load one or more discs from a storage hopper into a data recorder to copy data to multiple discs without stopping and waiting for a user to load and unload multiple discs. Once the discs are recorded, a printing head operates to automatically print or label discs prior to dispensing or storing the recorded discs in a hopper. Known devices that record data to multiple discs are typically designed for “desk top” use and typically include a lift or flip top that opens vertically to fill and/or empty discs from the storage hoppers.

### SUMMARY OF THE INVENTION

The present invention relates to a data recording assembly or device operable to copy or record data to one or more discs. The data recording assembly disclosed includes a rack mountable housing. The rack mountable housing disclosed has a width dimension sized to fit within an opening or spacing between rails of the rack. The data recording assembly is mounted to rails on the rack via mounting flanges. Mounting flanges include slots which align with openings on the rails to connect the mounting flanges to the rack. In illustrated embodiments, the mounting flanges are formed integral with the housing or on a separate bracket or shelf unit which is secured to the rack to support or mount the data recording assembly on the rack.

### BRIEF DESCRIPTION OF THE DRAWINGS

FIG. 1 illustrates a data recording assembly including a rack mountable housing and mounting flanges to connect the assembly to a rack.

FIG. 2 is a more detailed illustration of the data recording assembly of FIG. 1 mounted to the rack.

FIG. 2A illustrates an embodiment of a spacing arrangement between mounting openings on rails for the rack illustrated in FIG. 2.

FIG. 3 is a front view illustration of the data recording assembly including a face plate having an extended width to form the mounting flanges for the rack mountable housing.

FIG. 4 is a top view illustration of the data recording assembly illustrating operating components enclosed within the rack mountable housing.

FIG. 5 is a block diagram illustration of operation control for the data recording assembly illustrated in FIG. 1.

FIG. 6 is a more detailed illustration of a face plate and mounting flanges.

FIG. 7 is a detailed illustration of an alternate embodiment of a mounting flange for a rack mountable housing.

FIG. 8 is a flow chart illustrating steps for recording data to discs using a data recording device of the type described.

FIGS. 9-13 illustrate an alternate embodiment of a rack mountable recording assembly and shelf unit.

### DETAILED DESCRIPTION OF ILLUSTRATIVE EMBODIMENTS

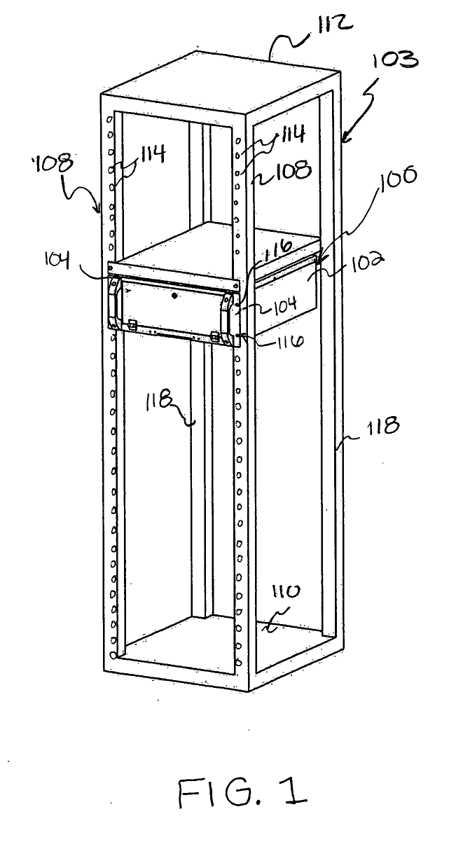

FIG. 1 is a perspective illustration of an embodiment of a recording assembly 100 that can be used to copy or record data to discs, such as optical or compact discs, the operation of which will be described more fully herein. In the embodiment shown, the recording assembly 100 is enclosed in a rack mountable housing 102 which is shaped for stacking in a rack 103 or similar frame structure of the type illustrated in FIG. 1. The recording assembly 100 shown also includes laterally extending mounting flanges 104 that are used to attach the recording assembly 100 to rack 103.

The rack 103 illustrated in FIG. 1 is a free standing rack and includes a plurality of spaced rails 108 that extend between a base 110 of the rack 103 and top 112 of the rack 103. Rails 108 as shown form support posts for the rack. Rails 108 include a plurality of spaced openings or holes 114 to fasten a plurality of stacked components to the rack. In the embodiment shown, the mounting flanges 104 of recording assembly 100 include slots or openings 116. Slots or openings 116 are located or spaced based upon industry standard spacing of the openings or holes 114 on the rails 108. For example, the slots 116 on the mounting flanges 104 are located or spaced based upon Electronic Industries Alliance (EIA) standards or other standards defining the spacing and dimensions of openings 114.

The illustrated rack 103 includes additional rails or posts 118 between the base 110 and top 112 to form a four post rack. Although in FIG. 1 a free standing four post rack is shown, application of the present invention is not limited to the particular free standing rack shown and the rack mountable assembly can be used with a wall mounted rack or unit as well as other frame structures. The term rack when referred to herein shall refer to any frame structure, including cabinets that support a plurality of stacked components and is not limited to the particular rack shown in FIG. 1. The term opening or holes 114 includes through holes, tapped holes, countersunk holes or window or square holes and application of the present invention is not limited to a particular opening or mounting hole configuration on rails 108.

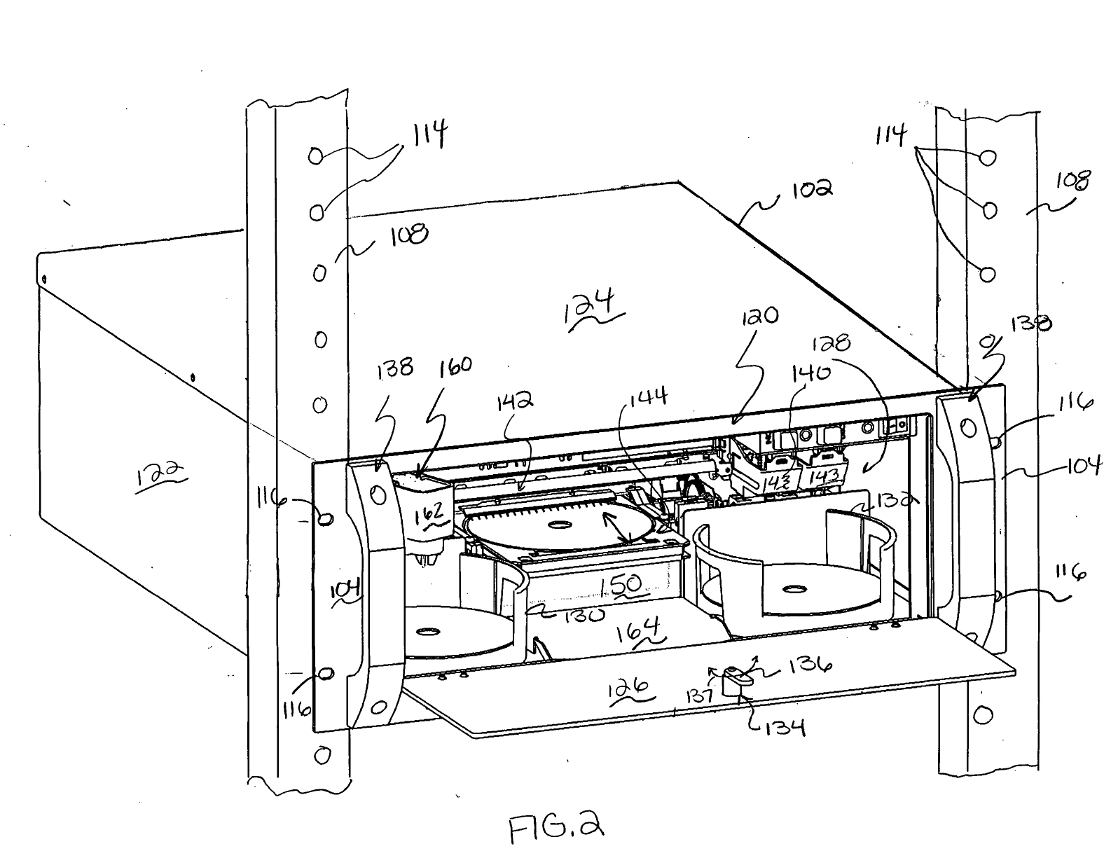

FIG. 2 is a more detailed illustration of the recording device 100 mounted to the rack. As shown, the housing 102 includes a front face 120 which as illustrated is generally vertically aligned when the recording assembly 100 is mounted to rack 103. In the embodiment shown, the housing 102 is generally rectangular shaped so that the front face 120 is generally perpendicular to opposed sides 122 (only one visible in FIG. 2) and an upper surface or cover 124 of the housing 102. Front face 120 includes a door 126 that opens and closes to access an inner chamber 128 of the housing 102.

While mounted on the rack 103, door 126 is opened (as shown in FIG. 2) to provide a front or horizontal load orientation to load discs into or empty discs from hoppers 130, 132. As shown door 126 includes a latch 134 with a rotatable latch arm 136 (shown in FIG. 2 in the locked position) to lock the door 126 in the closed position. Latch arm 136 is rotated as illustrated by arrow 137 to unlock and open the door 126 to load and unload discs. The front face 120 also includes a plurality of handles 138 on opposed sides of the door 126. The handles 138 as shown are generally vertically aligned relative to the upper surface 124 of the housing 102 and are used to grab and hold the recording assembly 100 in place while the device 100 is secured to the rack.

As previously described, the recording assembly 100 is secured to rack 103 via slots 116 on mounting flanges 104 which as shown have a laterally extending length. Mounting flanges 104 as shown in FIG. 2 include a plurality of (two) vertically aligned slots. The vertically aligned slots 116 are spaced based upon standard dimension spacing between vertically aligned openings 114 on rails 108. The slots 116 can be spaced to align with adjacent openings 114 or vertically aligned openings 114 that are separated by one or more openings. Example spacing for a 19 inch rack is approximately ⅝ of an inch. FIG. 2A illustrates an example or spacing pattern for vertical openings 114 along rails 108. In the example illustrated, the vertically aligned openings are non-uniformly spaced. For example, some adjacent openings are spaced ⅝ inches apart while others are spaced a half an inch apart.

The illustrated recording device or assembly 100 includes both recording and printing functions. The printing functions are implemented via a print head 140. Print head 140 is movable along rail 142 or track to print a label or information on discs supported in print tray 144. The print head 140 shown includes ink cartridges 143 to print labels or information on the discs that is readable without a transcription device. Example print heads include an inkjet print head, thermal print head or other print heads that print information on the disc that is readable without a transcription device. Example label or information includes date, time, source information, or other identification data.

The recording or copying function is implemented by a data recorder 150. An example data recorder 150 is illustrated in U.S. Pat. No. 6,327,230. The data recorder 150 receives an input disc and records (burns) or copies data, such as music, recordings and “back-up’ data, to the disc which is typically a “blank disc”. In the embodiment shown, the print tray 144 and data recorder 150 are supported in the rack mountable housing 102 in stacked relation to provide a compact design.

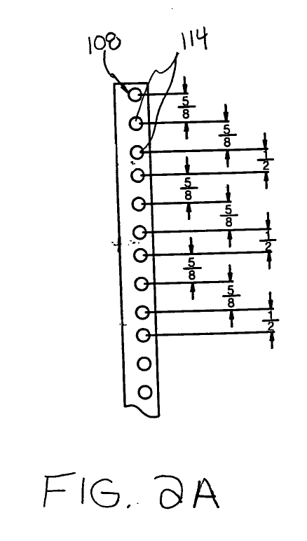

As previously described, the illustrated recording assembly 100 includes hoppers 130, 132 to store multiple discs for recording and printing functions. The illustrated hoppers 130, 132 are configured to store a plurality of or multiple discs in stacked relation. Discs are transported between hoppers 130, 132, the print tray 144 and data recorder 150 by a disc transport assembly 160 which in the illustrated embodiment includes a gripper mechanism or head 162. The disc transport assembly 160 picks-up and loads discs into print tray 144 and disc recorder 150. The disc transport assembly 160 deposits recorded discs in one of the hoppers 130, 132 or drops the recorded discs to a chute 164 for delivery through slot 166 on the front face 120 of the rack mountable housing 102 as illustrated in FIG. 3. An additional hopper (not shown) can be mounted to the front face 120 to store discs ejected through slot 166.

In FIG. 3, door 126 is formed of a clear or transparent material and the hoppers 130, 132 and other components are externally visible. The transparent door 126 allows a user to check whether if a hopper is empty or full so that the user can fill or empty hoppers as needed. Door 126 is hingedly connected to the housing 103 along a lower edge 168 of the door 126 to form a generally horizontal hinged seam when mounted to the rack 103.

The gripper mechanism or head 162 shown in FIG. 3 includes a plurality of gripper fingers 172 that are actuated between a contracted position and expanded gripping position via gripper actuator 174. Illustratively gripper actuator 174 could be a solenoid actuator or alternatively another mechanical or electromechanical actuator. In the contracted position, the gripper fingers 172 are aligned for insertion into an opening in the disc. In the expanded position, the gripper fingers 172 engage the disc for transport to the printing tray 144 and data recorder 150.

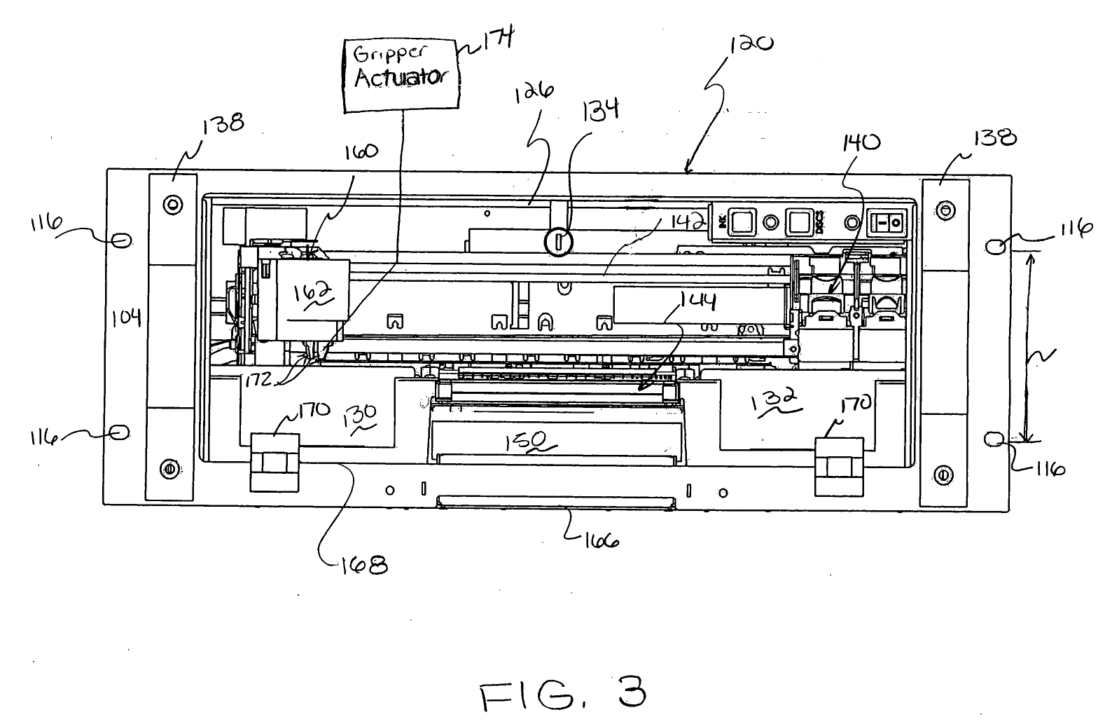

FIG. 4 is a top view of the recording device and rectangular shaped housing 102 shown with the top removed and illustrating a base surface 178 of the housing. As shown, housing has a rear end or face 180 spaced from front face 120. The rear end 180 of the housing 102 includes various connectors or sockets to interface with a host system or server 182 and other devices to receive record data 184 and print data 186 for operation. In the illustrated embodiment, the front face 120 includes a face plate 188 which has a width larger than a width dimension between sides 122 of the housing to cooperatively form the mounting flanges 140. Handles 138 are coupled to the face plate 188 and extend generally vertically relative to base 178.

In the illustrated embodiment, the gripper mechanism or head 162 is coupled to an arm assembly 190 which is moved through operation of a carriage 192. In the illustrated embodiment, the carriage 192 and print head 140 move along rail 142 and guide 198 through operation of a universal motor 200. Motor 200 drives a belt (not shown) to move the carriage 192 along rail 142 to transport the discs between hoppers 130, 132, print tray 144 and data recorder 150.

Motor 200 also moves print head 140 to form a universal drive assembly. In an illustrated embodiment, print head 140 is coupled to belt and moveable thereby. Carriage 192 selectively attaches to the print head 140 and is movable therewith to form the universal drive assembly. The carriage 192 is detached from the print head 140 to operate the print head 140 separately. Attachment and detachment of the carriage 192 can be implemented mechanically or electrically. An embodiment of a universal drive assembly is illustrated in more detail in U.S. Pat. No. 6,760,052.

The gripper mechanism or head 162 is movably coupled to carriage 192 through a lift assembly 204 (illustrated schematically) to raise and lower the gripper head or fingers 172 (not shown in FIG. 4). The lift assembly or gripper lift 204 raises and lowers the gripper head 162 to retrieve discs from and deposit discs into the hoppers 130, 132 and in addition, the gripper head 162 loads discs into and unload discs from the print tray 144 and data recorder 150. An example lift assembly 204 is illustrated in U.S. Pat. No. 6,760,052, although application is not limited to the particular lift assembly described.

In FIG. 4, discs from hoppers 130, 132 are loaded into print tray 144 which is movable between an extended position (not shown in FIG. 4) and retracted position to print label or information on the disc. In an illustrated embodiment one of the hoppers 130, 132 is designated as an input hopper and another is designated as an output hopper. Blank discs are retrieved from the input hopper and recorded and printed discs are deposited in the output hopper. Alternatively both hoppers 130, 132 are used as input hoppers and the recorded discs are deposited to chute 164 as previously described.

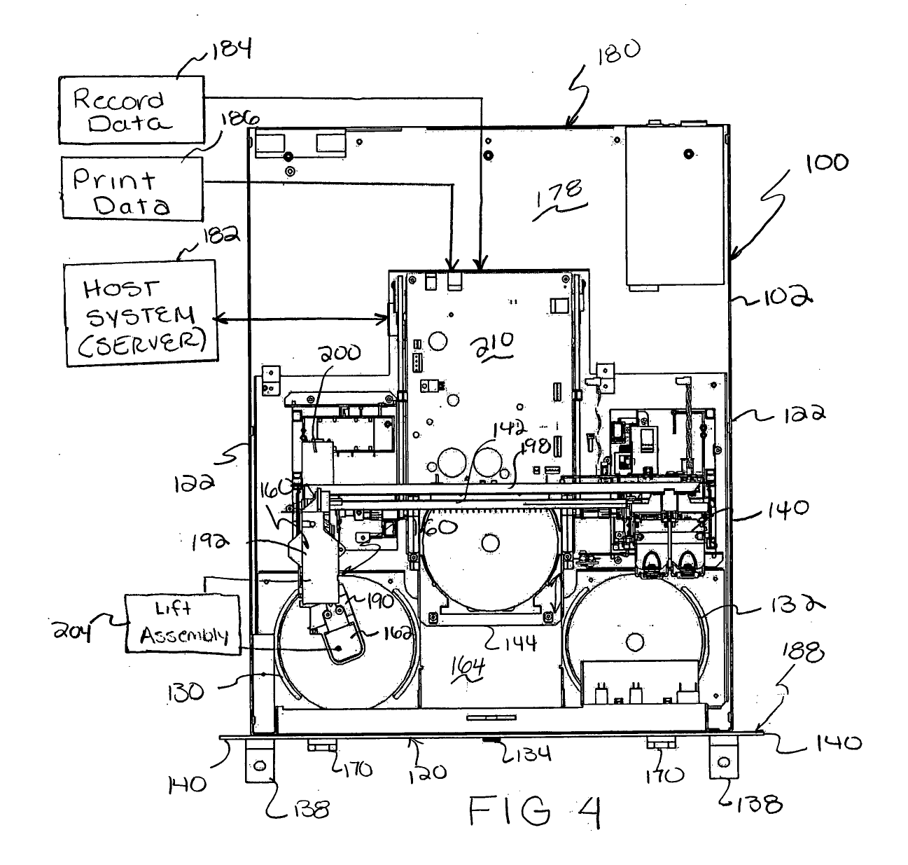

As shown in FIG. 4, the host system or server 184 interfaces with a controller 210 to implement print, data recording and transport functions of the device. For operation, record data 184 is inputted to the data recorder (not shown in FIG. 4) and the print data 186 is provide to print assembly 212 shown schematically in FIG. 5. As shown in FIG. 5, controller 210 operates disc transport assembly 160, recorder device 150, print assembly 212 and universal drive assembly 214 (illustrated schematically in FIG. 5) to move the carriage 192 and print head 140. Controller 210 is configured to synchronize operation of carriage 192, gripper lift 204 and gripper mechanism or head 162 to lift and transport discs to implement the print and recording functions.

Discs are loaded into recorder tray 216 (illustrated schematically) through operation of the gripper head 162. Operation of the recorder tray 216 is synchronized by the controller 210 to open the tray to load discs from the gripper head 162, close the tray 216 to record data and reopen the tray 216 following the recording process. When the tray 216 is closed, data is copied or recorded on the disc by a recorder head 218 illustrated schematically.

Operation of the print tray 144 and print head 140 of print assembly 212 is also implemented through controller 210. The print tray 144 is extended to load discs from gripper head 162 and retracted to print data through operation of print head 140 via operation of the universal or other drive assembly 214. Following printing, the print tray 144 is extended to unload the printed disc from the print tray 144.

As previously described in the embodiment illustrated in FIG. 3, the print tray 144 and data recorder 150 are in stacked relation. Thus, recording tray 216 is extended to load discs and retracted for recording. After the discs are recorded, the tray 216 is extended to remove the recorded discs. The recorded discs are unloaded from tray 216 and are raised via lift 204. Thereafter, tray 216 is closed and print tray 144 is extended to load the recorded discs. The gripper head 162 is then lowered to load the recorded discs into the print tray 144. Print tray 144 is then retracted to print data 186 on the discs.

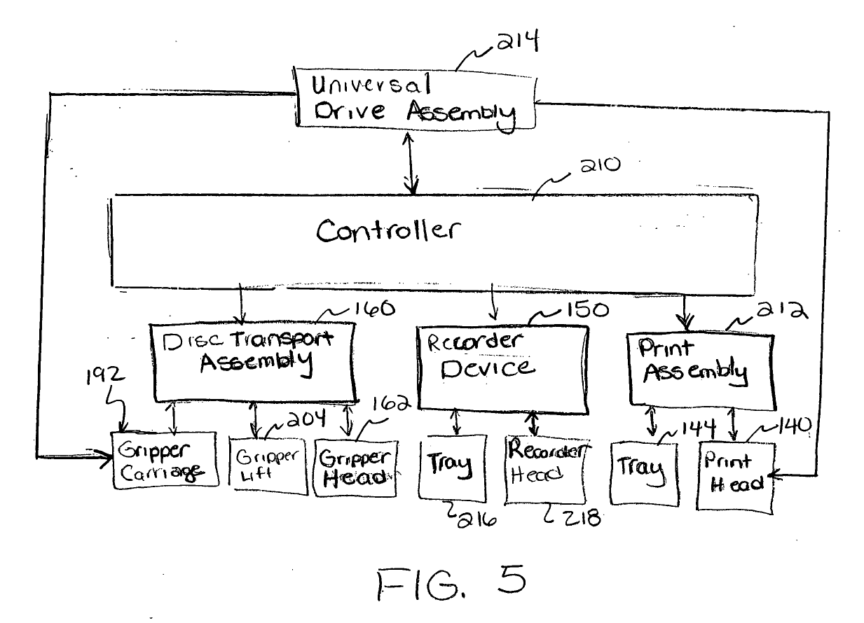

As previously described in the embodiment of FIG. 4, the mounting flanges 140 are formed integrally with a face plate 188 along the front face 120 of the rack mountable housing 102. As shown in more detail in FIG. 6, width 220 of housing between sides 122 is sized smaller than a typically spacing or gap 224 between rails 108. For a standard 19 inches rack (having a 19 inch width), the spacing of separation or gap 224 between rails 108 is illustratively approximately 17.72 inches or 450 mm. The faceplate 188 has a larger width dimension to form the mounting flange 140 having a flange body defined by an extended edge 226 of the face plate 188 extending laterally beyond sides 122 of the rack mountable housing 102. The flange body abuts rails 108 when the housing is inserted between rails 108. The slots 116 on opposed mounting flanges 140 are located and laterally spaced to align with openings 114 on the spaced rails 108 to attach the device to the rack. In the embodiment shown, slot or opening 116 has an elongate length dimension to accommodate variations in the lateral spacing between openings 114 on the spaced rails 108 to connect the mounting flanges 104 to rack 103. Example lateral spacing between openings 114 on opposed rails is 18.31 inches or 465 mm.

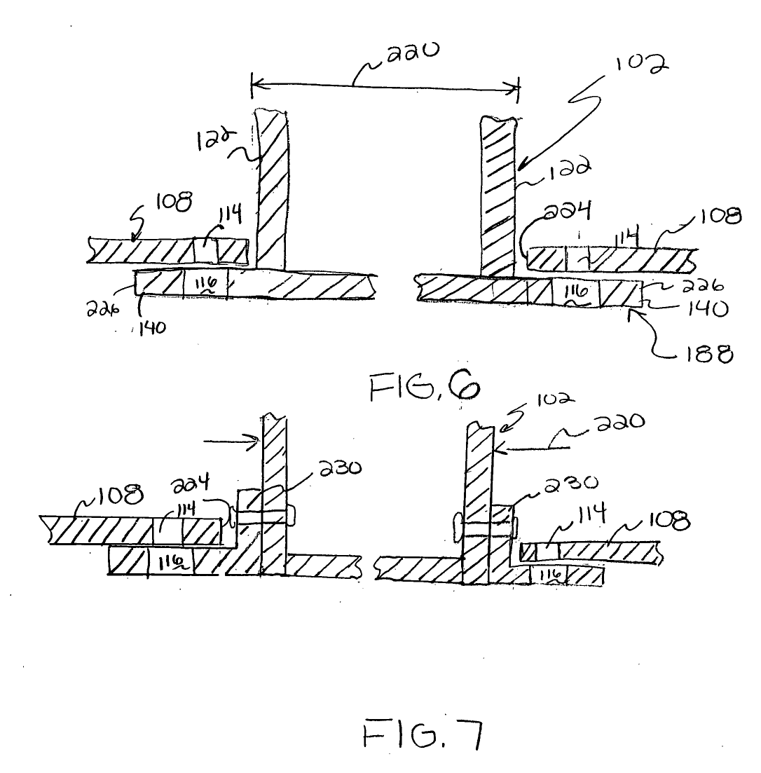

In an alternate embodiment illustrated in FIG. 7, where like numbers are used to identify like parts, the mounting flanges are formed on a separate bracket or brackets 230 (collectively referred to as a bracket assembly) that attach to the housing 102. In the illustrated embodiment, brackets 230 attach to sides 122 of the housing via fasteners that extend through openings on a side wall of the housing 102. Similarly, embodiments of the bracket assembly include a plurality of vertically aligned slots 116 which connect to vertically aligned openings 114 on the rails 108 as previously described. Although a particular attachment or connector is shown, other structures and attachment mechanism can be implemented to attach mounting flanges to the rack mountable housing 102.

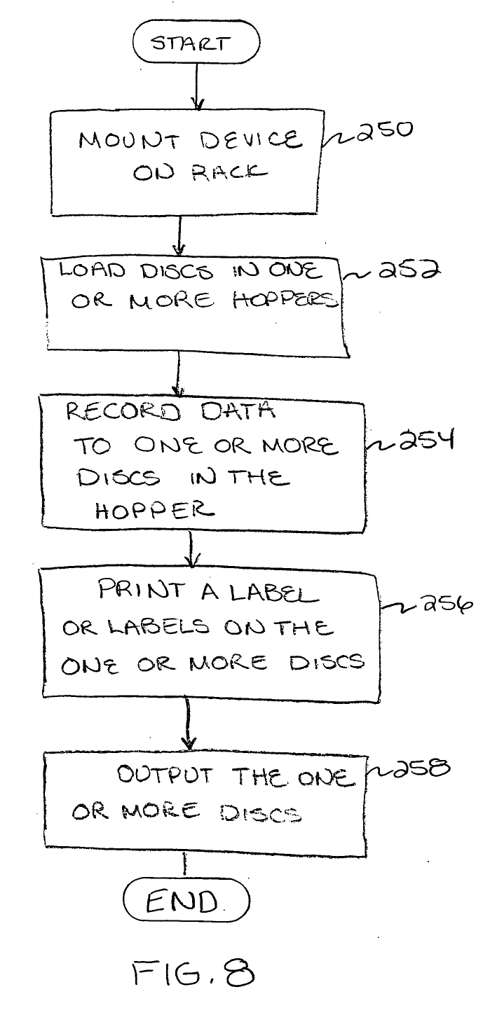

FIG. 8 is a flow chart illustrating the steps for recording data to discs as described above. As shown in step 250, the recording assembly 100 is mounted on the rack 103. In particular, the recording assembly is mounted to the rack 103 by inserting fasteners through slots 116 in the laterally extending mounting flanges 104 and openings 114 in the rails.

In step 252, a plurality of discs are loaded into one or more hoppers 130, 132. Data is recorded to one or more discs in the one or more hoppers 130, 132 as illustrated in step 254. For example in the illustrated embodiment, discs are unloaded from the hopper 130, 132 and transported to the recorder device 150 by the transport assembly 160. Discs are loaded into the data recorder 150 to record or copy data to the discs.

In step 256, labels (or other information) are printed on the one more discs and the printed discs are outputted as illustrated by step 258. The step 256 of printing labels in the illustrated embodiment includes loading the one or more discs into a print tray and retracting the print tray to print the labels on the discs via operation of the print head 140. Thereafter, the print tray 144 is extended to unload the printed discs. The discs can be deposited or outputted to an internal hopper or external hopper or chute 164 as previously described.

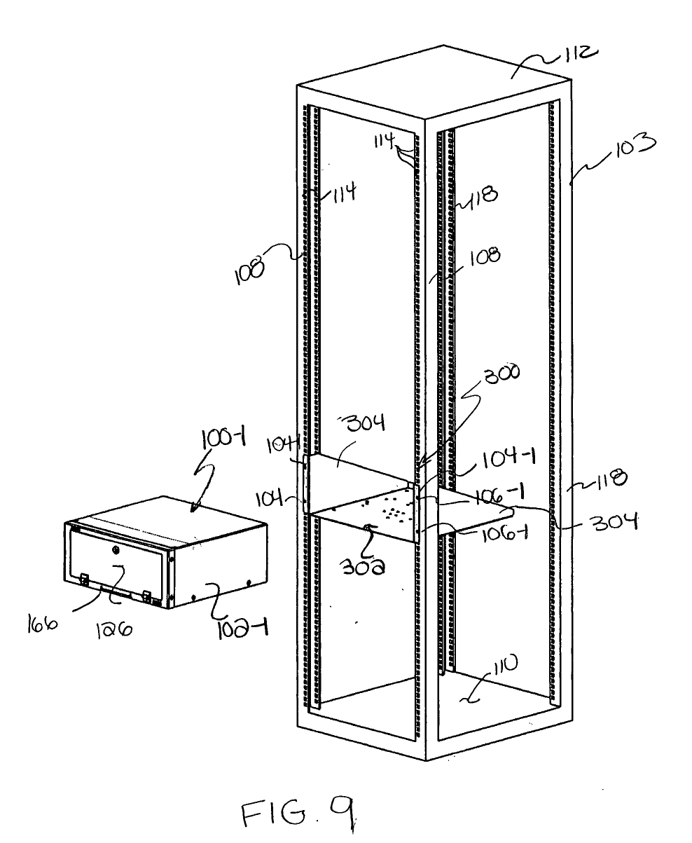

FIGS. 9-13 illustrate an alternate embodiment where like numbers are used to refer to like parts in the previous FIGS. In the illustrated embodiment of FIGS. 9-13, the mounting flange(s) 104-1 and openings 106-1 are formed on a separate shelf unit or mounting assembly 300. Shelf unit or assembly 300 includes a support platform 302 and opposed sides 304. In the embodiment shown, mounting flange(s) 104-1 extend laterally from opposed sides 304 so that mounting flanges 104-1 abut openings 114 on rails 108 to secure the shelf unit 300 to rack 103. In the illustrated embodiment, rails 108 are “U” shaped rails, however, application of the present invention is not limited to “U” shaped or 90 degree standard rails and other rail configuration known in the art can be used, such as rails configurations having a return flange.

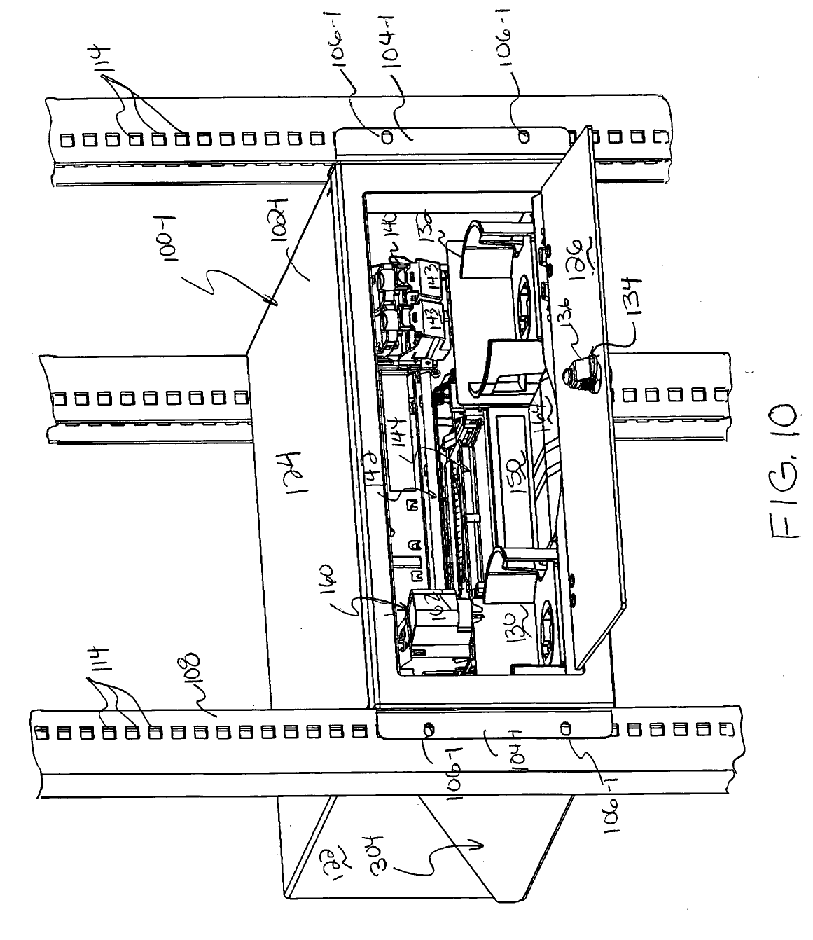

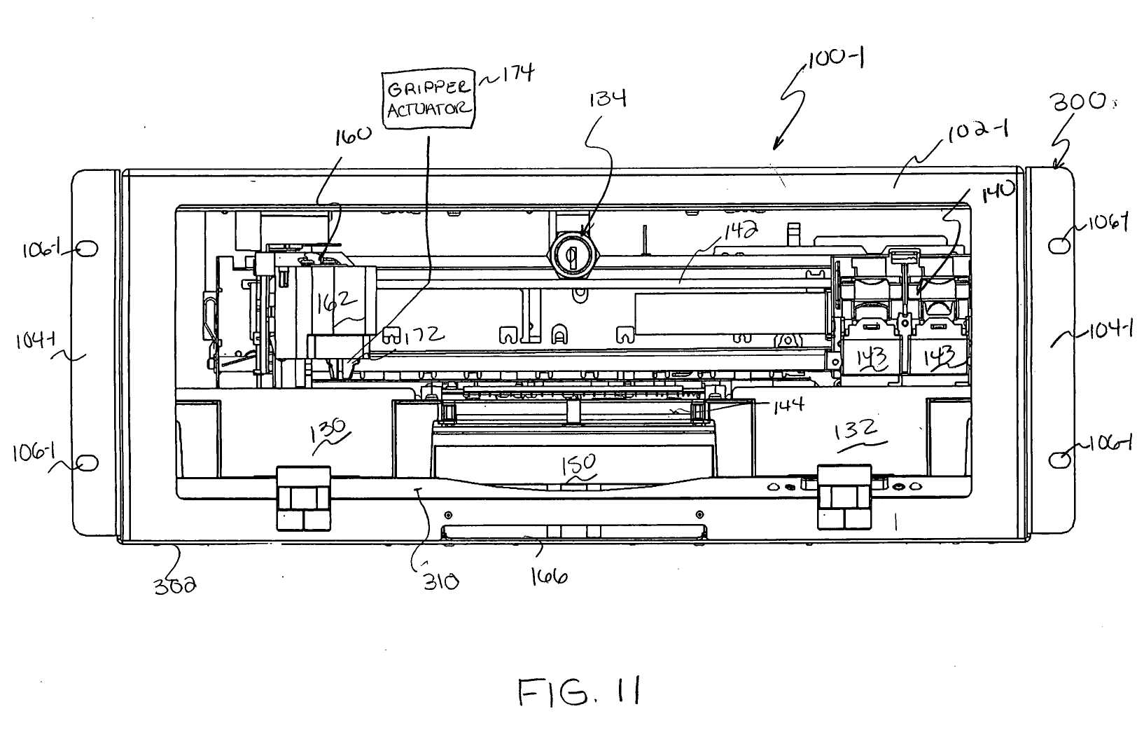

Shelf unit 300 as shown includes an open front end to slideably insert the recording assembly 100 so that the recording assembly 100 is supported on platform 302 as illustrated in more detail in FIG. 10-11. In the embodiment shown in FIGS. 9-10, sides 304 have a relatively tall height dimension at the front end (proximate to the mounting flanges 104-1) and taper downward towards a rear end of the shelf mounting unit 300. A surface of the platform 302 as shown includes a pattern of holes or recessions to accommodate various external features on the housing of the recording assembly 100-1. The holes or recessions allow the housing 102 to lay flat on the platform 302 against the platform surface. In contrast to FIG. 3, the illustrated embodiment does not include handles on the front face of the recording assembly 100. Additionally as shown in FIG. 11, a bracket 310 extends along the seam between the door 126 and front face of the illustrated recording assembly 100. Bracket 310 includes a contoured portion proximate slot 166 to provide clearance for the discs dispensed through chute 164.

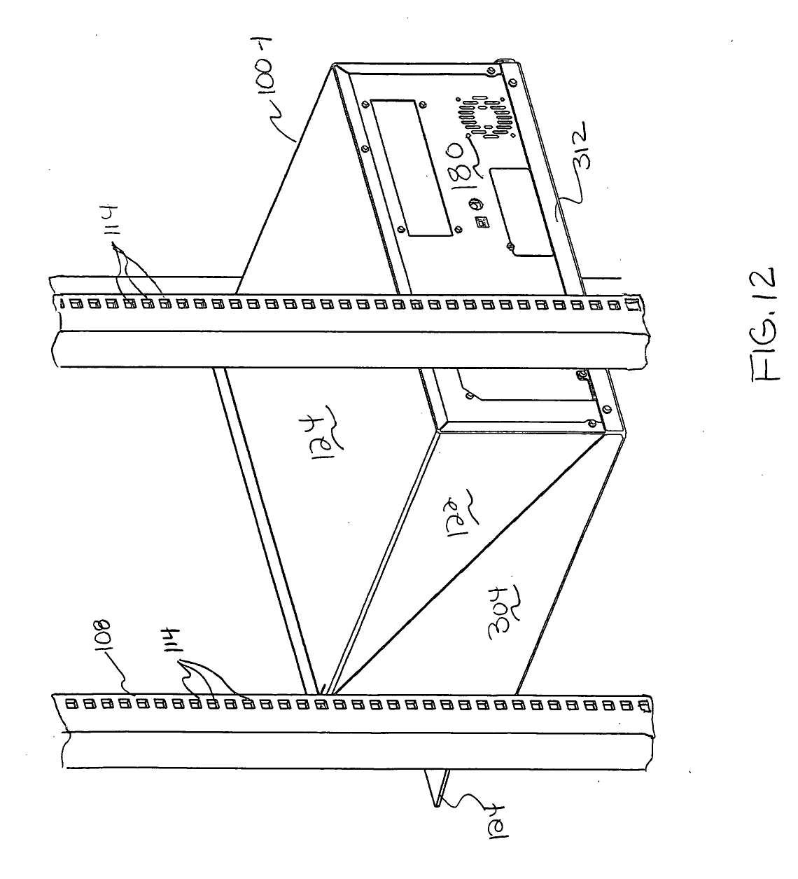

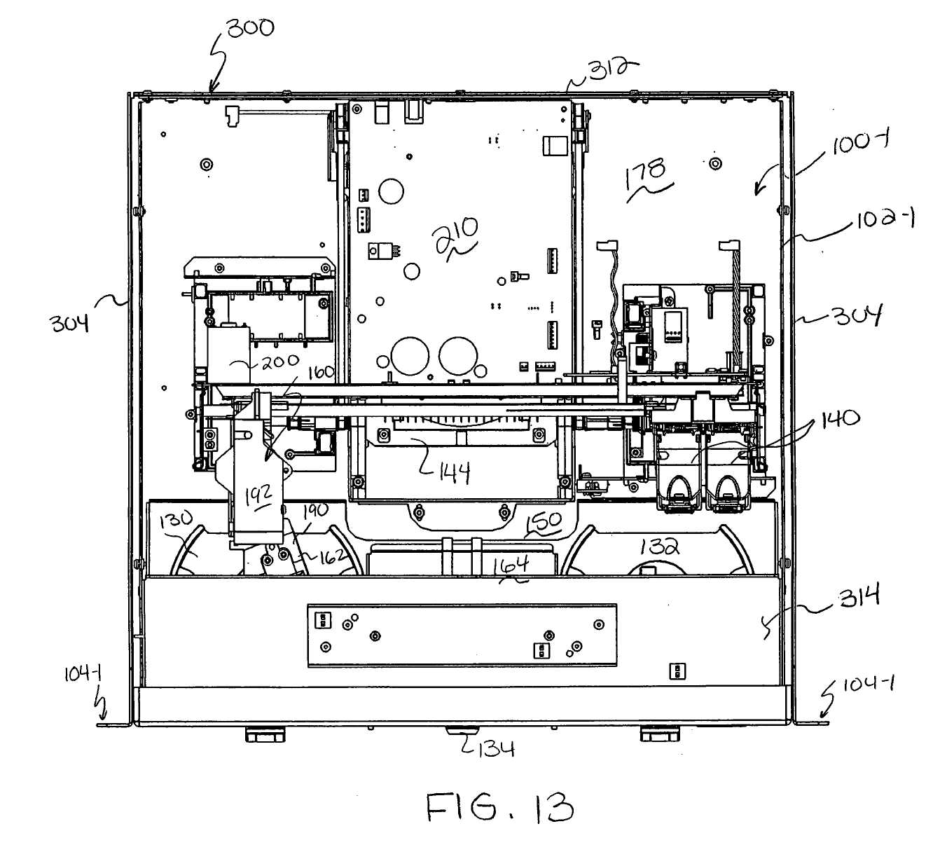

As visible in FIGS. 12-13, a rear portion of the shelf mounting unit 300 includes a back plate or back edge 312 that extends between opposed sides 304. As shown, when the recording assembly 100-1 is inserted on shelf unit 300, the rear face 180 of the recording device 100-1 abuts the back edge 312 of the shelf unit 300. To limit movement, the rear end or face 180 of the recording assembly 100-1 can be fastened to the back edge 312 of the shelf unit 300 as shown. In FIG. 13, the cover or top 124 is removed to illustrate operating components of the device. As shown, the device 100-1 includes an upper bracket or plate 314 proximate to the front end of the device to mount lighting devices such as a LED-light emitting diode light source.

Although the present invention has been described with reference to preferred embodiments, workers skilled in the art will recognize that changes may be made in form and detail without departing from the spirit and scope of the invention.

What is claimed is:

1. A recording assembly comprising:
a rack mountable housing having a width dimension between opposed sides smaller than a width dimension between spaced rails of a rack and the housing being mountable through openings formed in mounting flanges that extend laterally beyond the opposed sides of the housing to align with openings of the spaced rails of the rack and the mounting flanges being formed integrally with the rack mountable housing or connectable to the rack separate from the rack mountable housing;
a data recorder enclosed within the rack mountable housing and operable to receive data and record or copy the data on a disc; and
a printing assembly enclosed with the rack mountable housing including a printing head operable to print labels or information on the disc.

2. The recording assembly of claim 1 and further comprising:
at least one hopper configured to store a plurality of stacked discs; and
a disc transport assembly operable to retrieve one or more of the plurality of stacked disc from the at least one hopper and load the one or more discs in the data recorder to record or copy the data on the one or more discs.

3. The recording assembly of claim 2 including a plurality of hoppers configured to storage a plurality of stacked discs and the disc transport assembly includes a gripper head movable along a track to load the plurality of stacked discs into and/or unload the plurality of stacked discs from the plurality of hoppers.

4. The recording assembly of claim 1 wherein the rack mountable housing includes a face plate along a front face of the housing and the face plate includes an extended width dimension larger than a width dimension between the opposed sides of the rack mountable housing to form the integral mounting flanges extending laterally beyond opposed sides of the housing.

5. The recording assembly of claim 1 wherein the mounting flanges each include at least two generally vertically spaced openings to align with vertically spaced openings on the rails of the rack.

6. The recording assembly of claim 1 in combination with a shelf unit assembly including the mounting flanges and the openings connectable to the rack and the rack mountable housing being supportable on a platform of the shelf unit assembly.

7. The recording assembly of claim 6 wherein the shelf unit assembly includes a back edge or plate and a rear face of the rack mountable housing is secured to the back edge or plate of the shelf unit assembly.

8. The recording assembly of claim 1 wherein a front face of the rack mountable housing includes at least one handle having a generally vertical alignment when the recording assembly is mounted to the rack.

9. The recording assembly of claim 1 wherein a front face of the rack mountable housing includes a door pivotally connected to the housing along a generally horizontal seam formed along a lower edge of the door.

10. The recording assembly of claim 1 wherein a front face of the rack mountable housing includes a door hingedly coupled to the housing and is opened to front load discs or ink cartridges into the rack mountable housing.

11. The recording assembly of claim 10 wherein the door includes a latch having a latch arm rotatable between a latched position and an unlatched position.

12. The recording assembly of claim 1 in combination with a 19 inch rack having a generally 19 inch width.

13. A recording assembly comprising:
a rack mountable housing having a width dimension between opposed sides smaller than a width dimension between spaced rails of a rack and the housing being mountable through openings formed in mounting flanges that extend laterally beyond the opposed sides of the housing to align with openings of the spaced rails of the rack and the mounting flanges being formed integrally with the rack mountable housing or connectable to the rack separate from the rack mountable housing;
a data recorder enclosed within the rack mountable housing and operable to receive data and record or copy the data on a disc;
a least one hopper configured to store a plurality of stacked discs; and
a disc transport assembly including a gripper head configured to retrieve discs from the at least one hopper and load discs into and unload discs from the data recorder.

14. The recording assembly of claim 13 wherein the gripper head is coupled to a carriage which is operable by a universal drive assembly in combination with a print head.

15. The recording assembly of claim 13 wherein the mounting flanges are formed on a shelf unit connectable to the rack and the rack mountable housing is supported on a platform of the shelf unit.

16. The recording assembly of claim 13 wherein the mounting flanges include a plurality of generally vertically aligned openings that are spaced to align with multiple generally vertically aligned openings on the spaced rails of the rack.

17. The recording assembly of claim 15 wherein the shelf unit includes an opened front face, tapered sides and a raised back edge extending from the platform of the shelf unit.

18. A method comprising the steps of:
mounting a recording assembly on a rack;
loading a plurality of discs into one or more hoppers in the recording device configured to hold the plurality of stacked discs;
transporting one or more of the plurality of discs from the one or more hoppers to a data recorder;
loading the one or more discs in the data recorder; and
recording data to the one more discs.

19. The method of claim 18 and further comprising the steps of:
loading the one or more discs into a print tray; and
printing a label on the one or more discs.

20. The method of claim 18 and the step of mounting a recording assembly on the rack comprising the steps:
mounting a shelf unit to the rack; and
sliding the recording assembly through an opened front end of the shelf unit onto a support platform of the shelf unit.

21. The recording assembly of claim 1 wherein the openings on the mounting flanges are formed of an elongate slot having an elongate length dimension.

22. The recording assembly of claim 13 wherein the openings on the mounting flanges are formed of an elongate slot having an elongate length dimension.
